(19) United States
(12) Patent Application Publication
(10) Pub. No.: US 2020/0213159 A1
(43) Pub. Date: Jul. 2, 2020

(54) Radio Over Internet Protocol (RoIP) Expansion Device

(71) Applicant: Cubic Corporation, San Diego, CA (US)

(72) Inventors: Stephen Wilson, Shackleford (GB); Ian Morris, Shackleford (GB)

(73) Assignee: Cubic Corporation, San Diego, CA (US)

(21) Appl. No.: 16/709,229

(22) Filed: Dec. 10, 2019

Related U.S. Application Data
(60) Provisional application No. 62/786,185, filed on Dec. 28, 2018.

(51) Int. Cl. H04L 12/66; H04M 1/725; H04W 4/10; H04W 88/16; H04W 76/45; G06F 13/38

(52) U.S. Cl. CPC H04L 12/66; H04M 1/72527; H04W 4/10; G06F 2213/0042; H04W 76/45; G06F 13/385; H04W 88/16

(57) ABSTRACT

A RoIP expansion device can be used to expand the amount of available radio ports at a RoIP gateway. The RoIP expansion device includes a microcontroller for relaying audio and signaling information between the USB bus of a host device (e.g., a RoIP gateway device or computer) and a plurality of radio ports. According to some embodiments, the RoIP expansion device may include serial and/or general-purpose input/output (GPIO) ports to provide additional functionality.

### CROSS-REFERENCES TO RELATED APPLICATIONS

This application is a nonprovisional of and claims the benefit of priority to U.S. Provisional Patent Application No. 62/786,185, filed Dec. 28, 2018, entitled “RoIP CONNECT,” the entire contents of which are herein incorporated by reference.

### BACKGROUND

Radio over Internet Protocol (RoIP) is a technology that allows two-way radio communication between different radio and other communication platforms. Similar to Voice over Internet Protocol (VoIP), RoIP can be deployed over private and/or public data communication networks (e.g., the Internet), which may utilize any of a variety of wired and/or wireless technologies (in addition to radio technologies utilized between radios). Unlike VoIP, however, RoIP may additionally enable push-to-talk (PTT) functionality. Communications may be half- or full-duplex, depending on desired functionality and the capabilities of the various components of the RoIP system. Because RoIP uses a data communication network backbone to bridge various radio platforms, it can not only enable radios to communicate with other types of radios (e.g., radios utilizing different frequencies), but it can also enable radios to communicate with other types of non-radio devices, which may be far beyond the reach of a radio signal. With this functionality, RoIP can be extremely useful to first responders and others who frequently communicate using radios.

Deploying a RoIP solution, however, traditionally has been a difficult task. RoIP typically uses proprietary hardware—a “RoIP gateway device”—to bridge the radio network with the Internet Protocol (IP) infrastructure. Problematically, however, RoIP gateway devices traditionally have been standalone devices with a fixed number of radio ports and limited functionality. To implement a RoIP solution with a larger amount of radio ports than a single RoIP gateway device can provide, traditional RoIP solutions would require the use of a second, fully-functional RoIP gateway device. This can be undesirable in many circumstances because RoIP gateway devices can be both costly and particularly difficult to set up.

### BRIEF SUMMARY

Embodiments of the invention(s) described herein are generally related to expanding the amount of available radio ports for a RoIP gateway device by using an expansion device—“RoIP expansion device”—via a Universal Serial Bus (USB) port. The RoIP expansion device includes a microcontroller for relaying audio and signaling information between the USB bus of a host device (e.g., a RoIP gateway device or computer) and a plurality of radio ports. According to some embodiments, the RoIP expansion device may include serial and/or general-purpose input/output (GPIO) ports to provide additional functionality.

An example Radio over Internet Protocol (RoIP) expansion device providing radio ports for a RoIP system, according to the description, comprises a Universal Serial Bus (USB) input configured to plug into a USB port of a host device and connect to the RoIP expansion device to a USB bus of the host device, a plurality of radio ports, each radio port of the plurality of radio ports configured to connect with a respective radio of a radio network, and a microcontroller communicatively coupled with the plurality of radio ports and the USB input. The microcontroller is configured to associate each radio port of the plurality of radio ports with an audio device connected to the USB bus, relay audio communication between the plurality of radio ports and the host device via the USB bus, and communicate signaling information for each of the radio ports via a Human Interface Device (HID) connection.

An example method of providing radio ports with a Radio over Internet Protocol (RoIP) expansion device, according to the description, comprises associating a first radio port of a plurality of radio ports of the RoIP expansion device with an audio device connected to a Universal Serial Bus (USB) bus of a host device with which the RoIP expansion device is connected, subsequent to associating the first radio port with an audio device connected to the USB bus of the host device, relaying audio communication, via the USB bus, between a radio of a radio network and the host device, wherein the radio is connected with the RoIP expansion device at the first radio port, and communicating signaling information for the first radio port via a Human Interface Device (HID) connection.

An example non-transitory computer-readable medium, according to the description, has instructions embedded thereon for providing radio ports with a Radio over Internet Protocol (RoIP) expansion device. The instructions, when executed by one or more processors, cause the one or more processors to associate a first radio port of a plurality of radio ports of the RoIP expansion device with an audio device connected to a Universal Serial Bus (USB) bus of a host device with which the RoIP expansion device is connected, subsequent to associating the first radio port with an audio device connected to the USB bus of the host device, relay audio communication, via the USB bus, between a radio of a radio network and the host device, wherein the radio is connected with the RoIP expansion device at the first radio port, and communicate signaling information for the first radio port via a Human Interface Device (HID) connection.

### BRIEF DESCRIPTION OF THE DRAWINGS

For a more complete understanding of this invention, reference is now made to the following detailed description of the embodiments as illustrated in the accompanying drawings, in which like reference designations represent like features throughout the several views and wherein:

FIG. 1 is a simplified diagram of a RoIP system, according to an embodiment;

FIGS. 2A-2B are diagrams illustrating two different configurations in which a RoIP expansion device may be used, according to some embodiments;

FIG. 3 is a block diagram illustrating various hardware components of a RoIP expansion device, according to an embodiment;

FIG. 4 is a flow diagram of a process that can be performed to provide plug-and-play functionality for the RoIP expansion device, according to an embodiment; and

FIG. 5 is a flow diagram of a method at a RoIP expansion device of providing radio ports for a RoIP system, according to an embodiment.

In the appended figures, similar components and/or features may have the same reference label. Further, various components of the same type may be distinguished by following the reference label by a dash and a second label that distinguishes among the similar components. If only the first reference label is used in the specification, the description is applicable to any or all of the similar components having the same first reference label irrespective of the second reference label.

### DETAILED DESCRIPTION

The ensuing description provides embodiments only, and is not intended to limit the scope, applicability or configuration of the disclosure. Rather, the ensuing description of the embodiments will provide those skilled in the art with an enabling description for implementing an embodiment. It is understood that various changes may be made in the function and arrangement of elements without departing from the scope.

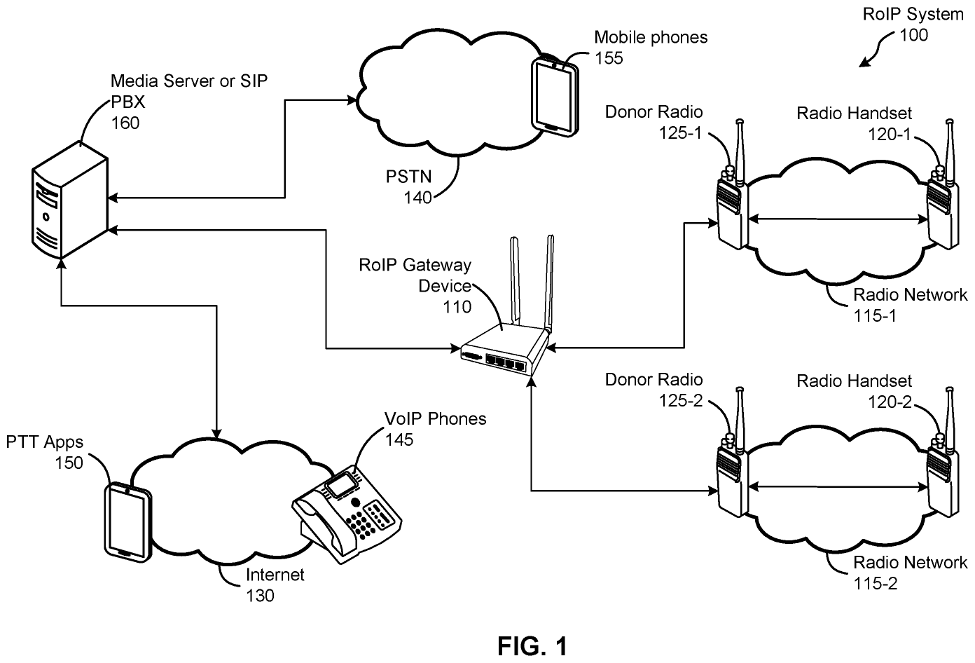

FIG. 1 is a simplified diagram of a RoIP system 100, according to an embodiment. Here, a RoIP gateway device 110, can operate to provide communications between various different components of the RoIP system 100. Arrows connecting the various components illustrated in FIG. 1 illustrate communication links between the components, and may be implemented using any of a variety of communication technologies (e.g., wired and/or wireless communication technologies, various protocols/standards, etc.). It will be understood that the various components provided in FIG. 1 are provided as examples. A RoIP system 100 may have more or fewer components, including any number of radios (e.g., donor radios 125 and/or radio handsets 120), radio networks 115, and/or other connected devices.

In RoIP system 100 illustrated in FIG. 1, two different radio networks 115-1 and 115-2 (collectively and generically referred to herein as radio networks 115) are communicatively coupled with the RoIP gateway device 110. Each radio network 115 may comprise any number of radio handsets 120 (e.g., as few as two or as many as dozens, hundreds, or more), configured to communicate with each other via wireless radio frequency (RF) signals. Depending on the capacity of the RoIP gateway device 110, other radio networks (not shown) may also be communicatively coupled with the RoIP gateway device 110.

In order to communicate with each radio network 115, the RoIP gateway device 110 uses a “donor radio” 125 that can communicate with radio handsets 120 of the respective radio network 115 as well as with the RoIP gateway device 110. Each donor radio 125 may be communicatively coupled with the RoIP gateway device 110 via a respective one radio port of the RoIP gateway device 110. Again, depending on the capacity of the RoIP gateway device 110, the RoIP gateway device may have any number of radio ports. (According to some embodiments, these radio ports may comprise RJ45 ports (also referred to herein as “four-wire ports”, but alternative embodiments may utilize any of a variety of alternative port types).)

Each of the radio networks 115 may utilize different radio platforms (different manufacturers, protocols, frequencies, etc.). And thus, radio handsets 120 from different radio networks 115 may not be able to communicate directly with each other (e.g., radio handset 120-1 may not be capable of communicating directly with radio handset 120-2). However, the RoIP gateway device 110, can relay communications between different radio networks 115. That is, the RoIP it we device 110 can act as a bridge, communicatively connecting different radio networks 115 communicatively coupled with the RoIP gateway device 110.

Data communicated between the RoIP gateway device 110 and donor radios 125 may vary, depending on desired functionality. In addition to audio (both transmit and receive), data can also include PTT and (Carrier Operated Relay) COR signaling, which can enable the PTT functionality. According to some embodiments, a custom cable may be used to connect an interface of each donor radio 125 (e.g., an ear piece jack) to a radio port of the gateway device 110.

As previously noted, the RoIP gateway device 110 can further enable communication channels between radio networks 150 and an IP infrastructure, including the Internet 130 and a public switched telephone network (PSTN) 140. That is, the RoIP gateway device 110 can enable radio handsets 120 of a radio network 115 to engage in audio communications with Internet-connected devices (including, for example, VoIP phones 145, mobile and/or other connected devices executing PTT applications (“apps”) 150, and the like) and/or phones (including, for example, mobile phones 155) of a PSTN 140. Additionally or alternatively, the RoIP gateway device 110 can allow radio handsets 120 to communicate with remote radio networks (not shown) coupled with remote RoIP gateway devices (not shown) communicatively coupled with the Internet 130. As such, radio handsets 120 are allowed to communicate with devices outside (and potentially remote from) their respective radio networks 115. To provide communications with IP-connected devices, the RoIP gateway device 110 can be coupled with a media server or Session Initiation Protocol (SIP) Private branch Exchange (PBX) 160, as illustrated.

As also noted, RoIP gateway device 110 has limited expandability options. Oftentimes, for example, expansion of a first RoIP gateway device 110 (e.g., the addition of radio ports) requires connecting it with one or more additional RoIP gateway devices, then performing a complex setup that involves routing IP addresses, designating master and slave devices, and so forth. This can be a particularly burdensome experience, especially because users (e.g., police officers, firefighters, etc.) do not have the Information Technology (IT) know how of performing the setup. And thus, a technician (typically from the manufacturer or distributor of the RoIP gateway devices) is often needed to perform the setup. This can be particularly troublesome in emergency situations, for example, where a radio network needs to set up quickly.

Accordingly, embodiments address these and other issues by providing a RoIP expansion device that can easily plug into a data port (e.g., USB port) of the RoIP gateway device 110, providing “plug and play” functionality that allows users to quickly and easily expand the number of radio ports for the RoIP gateway device 110. Furthermore, the RoIP expansion device may also include one or more data ports into which one or more additional RoIP expansion devices may be inserted. As such, multiple RoIP expansion devices can be “daisy-chained” to allow for an even greater number of radio ports for the RoIP gateway device 110. For example, a first RoIP expansion device having four radio ports can be plugged into the RoIP gateway device 110 to expand the number of radio ports from four to eight. A second RoIP expansion device also having four radio ports may then be plugged into the first RoIP expansion device to further expand the total number of radio ports to 12. This ability to provide additional radio ports via the USB bus using simple hardware that plugs into a USB port provides the ability to quickly expand the capacity of the RoIP gateway device 110, without the need for sophisticated IT knowledge. Moreover, the RoIP expansion device can be much cheaper than a traditional RoIP gateway device 110, allowing for much cheaper expansion than an expansion utilizing additional RoIP gateway devices 110.

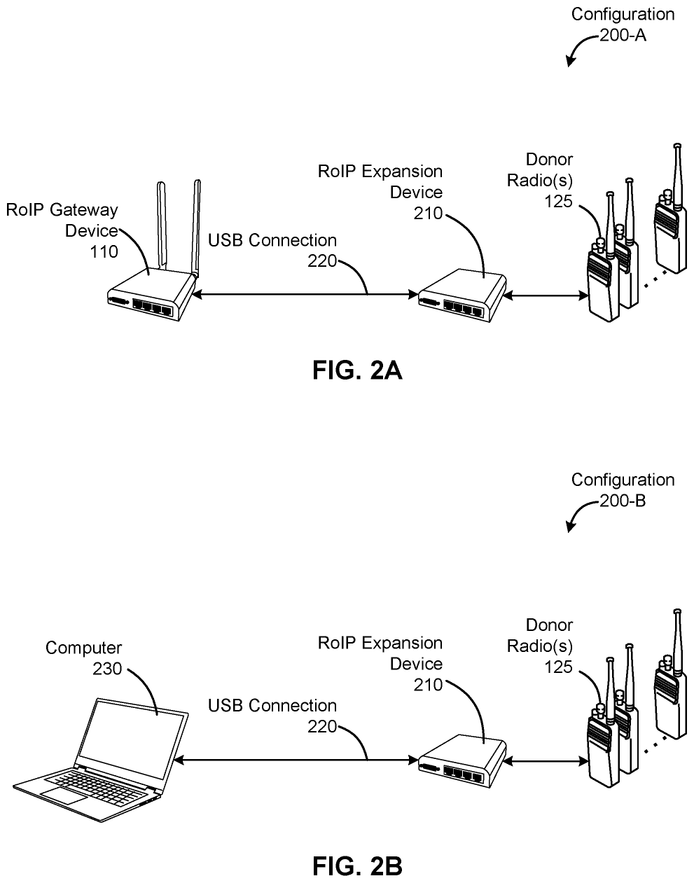

FIGS. 2A-2B are diagrams illustrating two different configurations 200-A and 200-B (collectively and generically referred to herein as configurations 200) in which a RoIP expansion device 210 may be used, according to some embodiments.

In the configuration 200-A of FIG. 2A, the RoIP expansion device 210 is communicatively coupled with the RoIP gateway device 110 via a USB connection 220. The RoIP expansion device 210 may be communicatively coupled with one or more donor radios 125 via a respective one or more radio ports. Each donor radio 125 may enable communications with a respective radio network (not shown) in a manner similar to the donor radios 125 illustrated in FIG. 1. Communication from the respective radio network can be relayed via the USB connection 220 to the RoIP gateway device 110, which may be communicatively coupled with various components of a RoIP system 100, as illustrated in FIG. 1. And thus, in instances where a RoIP gateway device 110 no longer has available radio ports to allow for additional radio networks 115 to be added to the RoIP system 100, the RoIP expansion device 210 can be connected with the RoIP gateway device 110 to allow for this functionality.

It can be noted that, although embodiments described herein use a USB connection 220, embodiments are not so limited. Alternative embodiments may, for example, utilize other data connection types, depending on desired functionality. They can be further noted that, not only may USB connection 220 (or another connection type) provide for communications between the RoIP gateway device 110 and RoIP expansion device with 210, but may also provide power to the RoIP expansion device 210.

In the configuration 200-B of FIG. 2B, the RoIP expansion device 210 is communicatively coupled with a computer 230. That is, in some embodiments, rather than being connected with a RoIP gateway device 110 having unique hardware for creating a RoIP system, the RoIP expansion device 210 can provide the necessary hardware (described in more detail below). The computer 230 can execute software for managing a RoIP system, thereby acting as a “virtual” RoIP gateway device. In the embodiments detailed below, therefore, references to a RoIP gateway device may refer to either a physical RoIP gateway device, or a virtual one executed by a computer 230.

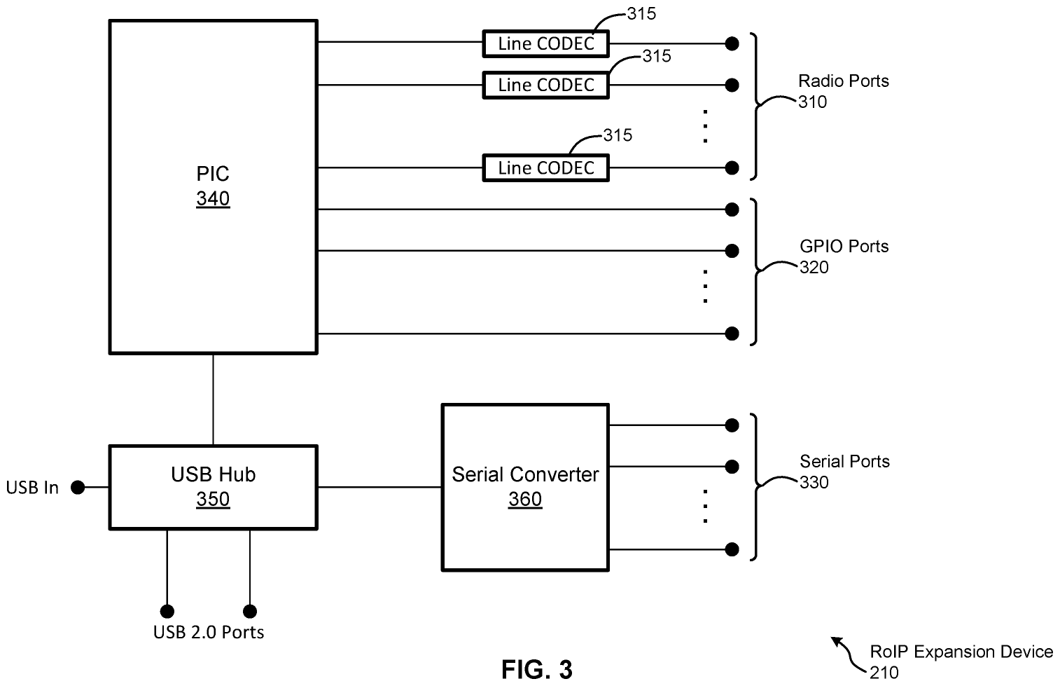

FIG. 3 is a block diagram illustrating various hardware components of a RoIP expansion device 210, according to an embodiment. It can be noted that alternative embodiments may include additional and/or alternative components. As noted, according to some embodiments, the selection of hardware and/or software components may be sufficiently low power to enable the RoIP expansion device 210 to be powered via a USB connection, and may allow additional RoIP expansion devices to be daisy-chained. (Alternatively, embodiments of a RoIP expansion device 210 may have a separate power source.) Software optimization can be made to enable sufficiently low bandwidth for data to be communicated between the RoIP expansion device 210 (and any additional RoIP expansion devices daisy-chained thereto) and the RoIP gateway device 110.

Here, the RoIP expansion device 210 includes four radio ports 310 to communicate audio in half- or full-duplex mode between a radio network 115 (via a donor radio 125) and the rest of the RoIP system 100. Radio ports 310 may also be referred to herein as four-wire ports, where a different wire dedicated to a different radio port function: audio in, audio out, RTT, and COR functionality.

Depending on desired functionality, the RoIP expansion device 210 may have any number of radio ports 310. Different donor radios 125 may be connected with different respective radio ports 310. As illustrated, each radio port 310 may have respective line codec circuitry 315 that can provide digital-to-analog and analog-two-digital conversion, as well as gain control (e.g., Automatic Gain Control (AGC)), volume control, and/or other audio functions, for audio respectively going to and coming from radios. In some embodiments, the line codec circuitry 315 may be capable of providing power to a microphone connected to a radio port. This line codec circuitry 315 further connects the radio ports 310 to a Peripheral Interface Controller (PIC) 340 (e.g., to audio interfaces of the PIC, such as standard PCM audio interfaces).

The PIC 340 is a programmable microcontroller used to communicate between the radio ports and the USB bus. In particular, the PIC can present audio devices that can be detected and used by the RoIP gateway device 110 via the USB bus. That is, rather than simply providing audio packets from the radio ports, the PIC 340 can provide audio devices detectable on the USB bus. This ability (along with the capability of the RoIP gateway device 110 to detect audio devices on the USB bus) helps provide the “plug-and-play” functionality of the RoIP expansion device 210.

The radio ports 310 may further provide a Human Interface Device (HID) connection to the radio ports (which may be separate from the audio connections and associated line codec circuitry 315) illustrated in FIG. 3. The USB HID class is a device class under the USB specification for computer peripherals, which has the flexibility to adequately manage COR and PTT signaling for the radio ports. Specifically, these connections can determine whether a donor radio plugged into a radio port is receiving audio (COR signaling), and an output to tell the donor radio to transmit over the air (PTT signaling). And thus, COR and PTT signaling can be managed for each of the radio ports individually, where an HID is associated with the radio ports. In some embodiments, the HID connections may comprise general-purpose input/output (GPIO) connections of the PIC (which may be separate from the GPIO ports 320 illustrated in FIG. 3).

According to embodiments, the HID may be treated as a separate device on the USB bus. Thus, PTT and COR are signaling for a particular radio port can handled via communication on the USB bus, and a specialized protocol can be used to indicate the particular audio port for which PTT and/or COR signaling applies.

The specific type of COR and PTT signaling may vary, depending on desired functionality. According to some embodiments, for example, when audio is to be communicated from the USB bus out to a donor radio 125 (and transmitted by the donor radio 125 to the radio network 115) connected to a radio port, the host device (e.g. the host RoIP gateway device 110) can send a command to the HID via the USB bus, instructing the HID to trigger the PTT signal of the respective radio port turn an LED associated with the respective radio port to green. Upon receiving those commands at the PIC, the PIC can execute the command for the respective radio port. (Audio frames would then follow, communicated to the respective radio port via the associated USB audio device.) Once the audio stops, another HID command may be sent from the host device to the PIC via the USB bus to lower the PTT signal and turn the LED off. For COR signaling, the PIC can monitor the radio ports to see if the COR signal is asserted and, if so, relay this to the host device via an HID communication on the USB bus.

It will be understood, that alternative embodiments may utilize alternative hardware, such as any of a variety of microcontrollers/microprocessors, specialized integrated circuits (e.g., an Application Specific Integrated Circuit (ASIC)), programmable circuitry (e.g., field-programmable gate array (FPGA)). In some embodiments, the functionality of the line codecs may be performed by the pic or similar circuitry.

As illustrated, embodiments may include a USB hub 350 and serial converter 360, although alternative embodiments may exclude one or both of these features. The USB hub 350 can include one or more additional USB ports to allow for daisy-chaining of RoIP expansion devices 210 as previously described, and/or to allow for other USB expansion capability.

The serial converter 360 allows the USB expansion device 210 to communicate with donor radios 125 via serial ports 330 (e.g., RS-232 ports). Thus, embodiments may include a serial port 330 for every radio port 310 in the RoIP expansion device 210. Because serial ports 330 can enable communications with connected donor radios 125 (e.g., military-grade radios and other radios with such capabilities), they can be used to reconfigure various radio settings for the donor radios 125. The serial converter 360 converts serial data to USB and vice versa. In some embodiments, the serial ports 330 may be additionally or alternatively capable of communicating audio data (e.g., serial over IP).

According to some embodiments, and as illustrated in FIG. 3, the PIC 340 may include one or more GPIO ports 320. These can be used in addition or as an alternative to serial ports 330 to provide any variety of functions beyond that provided by the radio ports 310. That is, in addition to the radio port functionality (which includes providing incoming audio, outgoing audio, COR signaling, and PTT signaling) the RoIP expansion device 210 can use the GPIO ports 320 (and/or serial ports 330) to provide variety of additional functions.

The type of functions provided by the GPIO ports 320 can vary, depending on desired functionality. For example, in some embodiments, the GPIO ports 320 can remote configuration/automation of donor radios 125 having a configuration interface (e.g., in cases where donor radios 125 may be otherwise incapable of remote configuration via serial ports 330). Additionally or alternatively, GPIO ports 320 may communicate metadata and/or other information about an audio port to/from a donor radio 125 connected to the audio port. This can include, for example, information conveying a radio channel change, waveform change, and/or loading. Other metadata may include volume change, voice operated switch (VOX) enable, and/or PTT enable signals. In some embodiments, for example, a GPIO ports 320 may be used to communicate a donor radio's ability to mux multiple audio channels, and further indicate which audio channel is associated with incoming and/or outgoing audio (communicated via a corresponding radio port 310). Other metadata may include a priority level for incoming and/or outgoing audio. GPIO ports 320 may additionally or alternatively be used to convey encryption keys for audio transmissions, sensor tethering, antenna steering, power/amplifier control, and the like.

In some embodiments, GPIO ports 320 may be used to provide information to a user via indicators. These indicators may comprise LED lights, speakers, etc. and may indicate information such as, low battery, signal strength, and the like. (To be sure, this information may be additionally or alternatively communicated by the GPIO ports 320 as metadata, in the manner described above.)

In some embodiments, GPIO ports 320 may be used to provide text messaging functionality. That is, in cases where a connected donor radio 125 is so equipped, GPIO ports 320 can be used to provide a communication channel for text messaging, separate from the audio channel for the donor radio 125 provided by the radio port 310.

In some embodiments, GPIO ports 320 may be dynamically configured by the PIC 340 to accommodate the needs of a RoIP system. For example, based on a determined type of donor radio 125 connected with the RoIP expansion device 210 (e.g., based on user settings and/or input via serial ports 330 and/or at least some GPIO ports 320), the PIC 340 may dynamically utilize GPIO ports 320 to provide on-demand functionality.

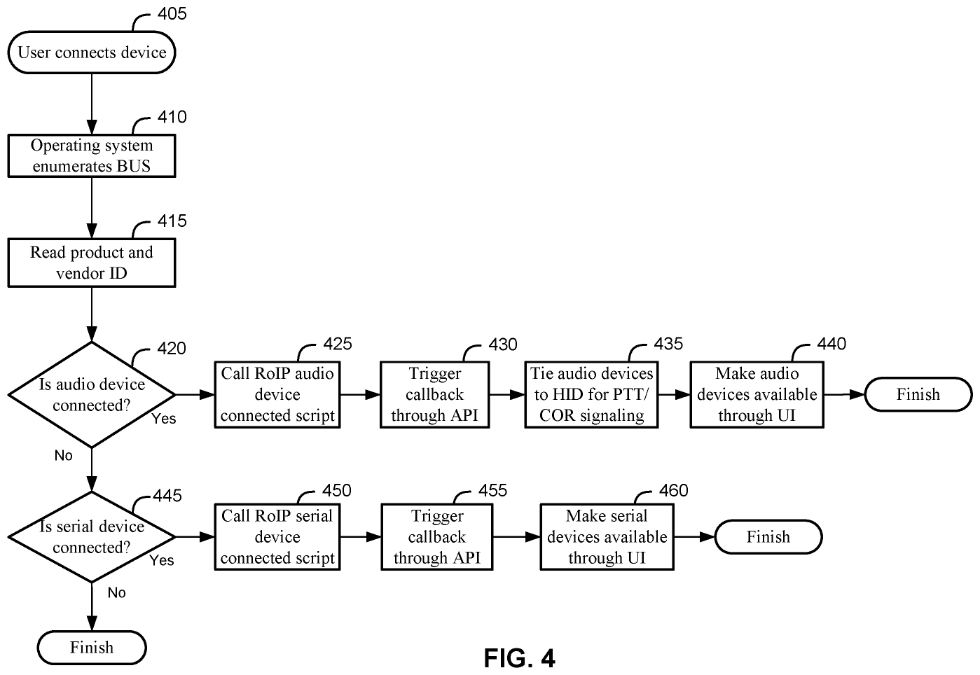

FIG. 4 is a flow diagram of a process that can be performed to provide plug-and-play functionality for the RoIP expansion device 210, according to an embodiment. Alternative embodiments may add, omit, combine, separate, rearrange, and/or otherwise alter the functionality described in each of the blocks of FIG. 4. As a person of ordinary skill in the art will appreciate, the functionality indicated in the various blocks shown in FIG. 4 can be carried out via hardware and/or software means of a RoIP expansion device 210 and/or RoIP gateway device 110. Additionally, although the flow diagram illustrates functions that can be taken when a device is connected with a radio port 310 and/or serial port 330, it will be understood that a similar process can be used when a device is connected with a GPIO port 320.

The process begins at block 405, the user connects the RoIP expansion device 210 to the RoIP gateway device 110 by plugging the USB input (labeled as “USB In” in FIG. 3) of the RoIP expansion device 210 into a USB port of the RoIP gateway device 110. In some embodiments, the RoIP gateway device 110 can execute software that monitors the USB bus to determine if and when devices are added thereto. Thus, when the user connects the RoIP expansion device 210 at block 405, the RoIP gateway device 110 can enumerate the USB bus at block 410 to determine that a new device is connected to the USB bus, read the product and vendor ID at block 415, and determine whether the attached device is a RoIP expansion device 210.

Here, donor radios 125 connected to the radio ports 310 of the RoIP expansion device 210 are processed by the PIC 340 so that they may be treated as audio devices on the USB bus. Thus, at block 420, it can further be determined whether an audio device is connected to the RoIP expansion device (e.g., a donor radio 125 connected to a radio port 310 of the RoIP expansion device 210). If so, the RoIP gateway device 110 can then execute a script at block 425 to re-enumerate (or re-index) audio devices on the USB bus associated with the RoIP gateway device 110. At block 430, a call back through the Application Programming Interface (API) of the RoIP gateway device 110 is triggered, causing the RoIP expansion device 210 to tie connected audio devices (donor radios 125 enumerated in block 425) to an HID for PTT/COR signaling. Finally, because the RoIP gateway device 110 may have a User Interface (UI) for RoIP network setup (e.g., accessible via a browser), the RoIP gateway device 110 can then make the new donor radios 125 available as audio devices within the UI at block 440.

As previously noted, associating a radio port with an HID (shown at block 435) allows the RoIP expansion device 210 to present the radio port (or a radio 125 connected to the physical radio port of the RoIP expansion device, the PIC 340, or the like) as an audio “object” to the radio gateway software of the RoIP gateway device 110 via the API. Moreover, in some embodiments, the RoIP expansion device 210 can enable support of a dynamically variable number of radio ports 310. That is, a platform utilizing the RoIP expansion device 210 may have one or more donor radios 125 connected and/or disconnected at any time. Once assigned a particular port designation in software, the RoIP expansion device 210 serial number is used to ensure that the same donor radio 125 retains these designations, regardless of connection status. This can ensure that the connected donor radios 125 remain consistently assigned in software configurations if, for example USB device enumeration is not always consistent.

The RoIP gateway device 110 can execute a similar process to make available serial devices connected to the RoIP expansion device 210. At block 445, a determination is made whether a serial device is connected to the RoIP expansion device 210. If so, a RoIP serial device connect script is called at block 450. At block 455, a callback is triggered through an API of the RoIP gateway device 110, and finally the serial devices are then made available through the UI of the RoIP gateway device at block 460. (It can be noted that, although block 445 is executed when a RoIP connect audio device is not detected, the functionality may also be performed in addition to blocks 425-440, in some embodiments.)

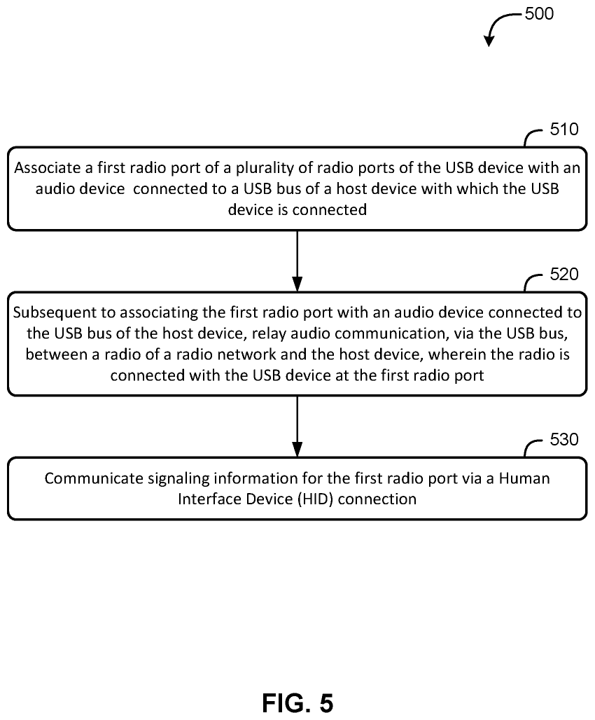

FIG. 5 is a flow diagram of a method 500 at a RoIP expansion device of providing radio ports for a RoIP system, according to an embodiment. Means for performing one or more of the functions illustrated in the blocks shown in FIG. 5 may comprise hardware and/or software components of a USB expansion device 210, such as those illustrated in FIG. 3. It will be understood that FIG. 5 is provided as a non-limiting example, and that alternative embodiments may perform similar functions in a different manner.

At block 510, the functionality comprises associating a first radio port of a plurality of radio ports of the RoIP expansion device with an audio device connected to a USB bus of a host device with which the RoIP expansion device is connected. Here, the USB device may comprise a RoIP expansion device 210, as illustrated in FIGS. 2 and 3 and discussed above. And as explained in the embodiments described above, the hosted device may comprise a RoIP gateway device 110, computer 230, or similar device. As also noted, associating radio ports with an audio device connected to a USB bus of the host device can facilitate plug-and-play functionality of the RoIP expansion device.

The functionality at block 520 comprises, subsequent to associating the first radio port with an audio device connected to the USB bus of the host device, relaying audio communication, via the USB bus, between a radio of the radio network and the host device. Here, the radio is connected with the RoIP expansion device at the first radio port.

At block 530, the functionality comprises communicating signaling information for the first radio port via an HID connection. As previously noted, HID class communications under the USB specification are flexible enough to enable management of signaling information, which can comprise PTT, COR, or both.

The hardware components of the RoIP expansion device may vary, depending on desired functionality. As noted in the above-described embodiments, the RoIP expansion device may comprise one or more USB ports and a USB hub communicatively coupled to the USB input of the RoIP expansion device, along with a microcontroller (e.g., PIC). In some embodiments, the RoIP expansion device may further comprise a plurality of serial ports, where each serial port corresponds to a respective radio port of the plurality of radio ports, and serial converter circuitry is communicatively coupled between the plurality of serial ports and the USB hub.

In the embodiments described above, for the purposes of illustration, processes may have been described in a particular order. It should be appreciated that in alternate embodiments, the methods may be performed in a different order than that described. It should also be appreciated that the methods and/or system components described above may be performed by hardware and/or software components (including integrated circuits, processing units, and the like), or may be embodied in sequences of machine-readable, or computer-readable, instructions, which may be used to cause a machine, such as a general-purpose or special-purpose processor or logic circuits programmed with the instructions to perform the methods. These machine-readable instructions may be stored on one or more machine-readable mediums, such as CD-ROMs or other type of optical disks, floppy disks, ROMs, RAMs, EPROMs, EEPROMs, magnetic or optical cards, flash memory, or other types of machine-readable mediums suitable for storing electronic instructions. Alternatively, the methods may be performed by a combination of hardware and software.

The methods, systems, devices, graphs, and tables discussed herein are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims. Additionally, the techniques discussed herein may provide differing results with different types of context awareness classifiers.

While illustrative and presently preferred embodiments of the disclosed systems, methods, and machine-readable media have been described in detail herein, it is to be understood that the inventive concepts may be otherwise variously embodied and employed, and that the appended claims are intended to be construed to include such variations, except as limited by the prior art.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate to in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate to in the context of the systems, devices, circuits, methods, and other implementations described herein.

As used herein, including in the claims, “and” as used in a list of items prefaced by “at least one of” or “one or more of” indicates that any combination of the listed items may be used. For example, a list of “at least one of A, B, and C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, and C” may also include AA, AAB, AAA, BB, etc.

What is claimed is:

1. A Radio over Internet Protocol (RoIP) expansion device providing radio ports for a RoIP system, the RoIP expansion device comprising:
a Universal Serial Bus (USB) input configured to plug into a USB port of a host device and connect to the RoIP expansion device to a USB bus of the host device;
a plurality of radio ports, each radio port of the plurality of radio ports configured to connect with a respective radio of a radio network;
a microcontroller communicatively coupled with the plurality of radio ports and the USB input, the microcontroller configured to:
associate each radio port of the plurality of radio ports with an audio device connected to the USB bus;
relay audio communication between the plurality of radio ports and the host device via the USB bus; and
communicate signaling information for each of the radio ports via a Human Interface Device (HID) connection.

2. The RoIP expansion device of claim 1, wherein microcontroller is configured to include, in the signaling information, Push To Talk (PTT) signaling, Carrier Operated Relay (COR) signaling, or both.

3. The RoIP expansion device of claim 1, further comprising one or more USB ports and a USB hub communicatively coupled to the USB input, the microcontroller, and the one or more USB ports.

4. The RoIP expansion device of claim 3, further comprising:
a plurality of serial ports, wherein each serial port corresponds to a respective radio port of the plurality of radio ports; and
serial converter circuitry communicatively coupled between the plurality of serial ports and the USB hub.

5. The RoIP expansion device of claim 1, wherein the RoIP expansion device is configured to operate with a host device comprising a RoIP gateway device or a computer.

6. The RoIP expansion device of claim 1, further comprising, for each radio port of the plurality of radio ports, respective line codec circuitry communicatively coupled between the respective radio port and the microcontroller, the respective line codec circuitry configured to provide analog signaling to the respective audio port and digital signaling to the microcontroller.

7. The RoIP expansion device of claim 6, further comprising, for each radio port of the plurality of radio ports, the respective line codec circuitry is further configured to provide gain control for the respective radio port.

8. The RoIP expansion device of claim 1, wherein the microcontroller is further configured to relay metadata associated with the audio communication, via one or more additional ports.

9. The RoIP expansion device of claim 1, wherein the microcontroller is further configured to relay text messaging between one or more additional ports and the host device via the USB bus.

10. The RoIP expansion device of claim 1, wherein the microcontroller is further configured to power one or more indicators associated with the audio communication using one or more additional ports.

11. A method of providing radio ports with a Radio over Internet Protocol (RoIP) expansion device, the method comprising:
associating a first radio port of a plurality of radio ports of the RoIP expansion device with an audio device connected to a Universal Serial Bus (USB) bus of a host device with which the RoIP expansion device is connected;
subsequent to associating the first radio port with an audio device connected to the USB bus of the host device, relaying audio communication, via the USB bus, between a radio of a radio network and the host device, wherein the radio is connected with the RoIP expansion device at the first radio port; and
communicating signaling information for the first radio port via a Human Interface Device (HID) connection.

12. The method of claim 11, wherein the signaling information comprises Push To Talk (PTT) signaling, Carrier Operated Relay (COR) signaling, or both.

13. The method of claim 11, wherein the RoIP expansion device comprises one or more USB ports and a USB hub.

14. The method of claim 13, wherein the RoIP expansion device further comprises:
a plurality of serial ports, wherein each serial port corresponds to a respective radio port of the plurality of radio ports; and
serial converter circuitry communicatively coupled between the plurality of serial ports and the USB hub.

15. The method of claim 11, wherein the RoIP expansion device is configured to operate with a host device comprising a RoIP gateway device or a computer.

16. The method of claim 11, further comprising, for each radio port of the plurality of radio ports:
providing analog signaling to the respective audio port,
and providing digital signaling to a port of a microcontroller communicatively coupled with the respective audio port.

17. The method of claim 16, further comprising, for each radio port of the plurality of radio ports, providing gain control for the respective radio port.

18. The method of claim 11, further comprising relaying metadata associated with the audio communication, via one or more additional ports of the RoIP expansion device.

19. The method of claim 11, further comprising relaying text messaging between one or more additional ports of the RoIP expansion device and the host device via the USB bus.

20. A non-transitory computer-readable medium having instructions embedded thereon for providing radio ports with a Radio over Internet Protocol (RoIP) expansion device, wherein the instructions, when executed by one or more processors, cause the one or more processors to:
associate a first radio port of a plurality of radio ports of the RoIP expansion device with an audio device connected to a Universal Serial Bus (USB) bus of a host device with which the RoIP expansion device is connected;
subsequent to associating the first radio port with an audio device connected to the USB bus of the host device, relay audio communication, via the USB bus, between a radio of a radio network and the host device, wherein the radio is connected with the RoIP expansion device at the first radio port; and
communicate signaling information for the first radio port via a Human Interface Device (HID) connection.
